(19) United States
(12) Patent Application Publication
(10) Pub. No.: US 2001/0003258 A1
(43) Pub. Date: Jun. 14, 2001

(54) Reciprocating pistons of piston-type compressor

(76) Inventors: Isamu Fukai, Fujioka-shi (JP); Masayuki Kurihara, Sawa-gun (JP); Keiji Shimizu, Isesaki-shi (JP)

Correspondence Address: Baker Botts L.L.P., The Warner, 1299 Pennsylvania Avenue, N.W., Washington, DC, 20004-2400, US

(21) Appl. No.: 09/729,321

(22) Filed: Dec. 5, 2000

(30) Foreign Application Priority Data
Dec. 9, 1999 (JP) P11-350265

(51) Int. Cl. F16J 9/00

(52) U.S. Cl. 92/240

(57) ABSTRACT

A piston-type compressor has several cylinder bores, each of which receives a piston assembly. The piston assembly reciprocates between a top dead center and a botom dead center in each cylinder bores. The piston assembly includes a piston and a piston ring. A groove is formed at or about a top dead center of an outer peripheral surface of the piston, and having a flat bottom surface thereof. The piston ring, which has a truncated cone-shape and may be made of resin, is fitted into the groove. An external diameter of the piston ring is greater than that of the piston. The piston ring is disposed in the groove, such that the wider edge of the ring opens toward a bottom dead center of the piston and a narrower edge of the piston ring abuts the bottom surface of the groove.

### BACKGROUND OF THE INVENTION

1. Field of the Invention

The present invention relates to piston-type compressor for use in a vehicular air conditioning system. More particularly, it relates to pistons, which reciprocate within cylinder bores.

2. Description of Related Art

A known piston-type compressor is described in, for example, Japanese Second (Examined) Utility Model Publication No. 4-52473. Such piston-type compressors have pistons, which recipronate in cylinder bores. A groove is formed at or about a top dead center portion of an outer peripheral surface of the piston. As shown in FIG. 4, a piston ring, which is a truncated cone-shaped ring and is made of resin, is disposed in the groove formed around the outer peripheral surface of the piston. The piston ring increases the sealing efficiency during compressor operation, and thereby increases the efficiency of compressor operation.

In such piston-type compressors, because compressed gas is drawn into a space between the groove of the outer peripheral surface of the piston and an interior surface of the piston ring, the sealing efficiency between the piston and a cylinder bore is increased. On the other hand, lubricating oil included in blow-by gas is largely prevented from seeping into a crank chamber. Consequently, it is difficult to maintain lubricating oil in the crank chamber, and lubrication in the crank chamber may be reduced. In particular, when the known piston-type compressor is a swash plate-type compressor, insufficient lubricating oil in the crank chamber may cause wear between a swash plate and shoes.

### SUMMARY OF THE INVENTION

An object of the present invention is to provide a securing structure for a piston assembly for use in piston-type compressors, thereby achieving improved sealing efficiency and improved efficiency of compressor operations.

Another object of the present invention is to provide a securing structure for a piston assembly for use in a piston-type compressor, which decreases inclination of the pistons and which retains lubricationg oil in the cylinder bores.

A further object of the present invention is to provide a securing structure for a piston assembly for use in a swash plate-type piston compressor, which decreases wear between the swash plate and shoes.

An embodiment of the present invention is a piston assembly for use in a compressor, such as a swash plate-type compressor or the like, which includes a plurarity of cylinder bores. Each cylinder bore receives the piston assembly, and the piston assembly reciprocates between a top dead center and a botom dead center position in its corresponding cylinder bore. The piston assembly comprises a piston and a piston ring. A piston has a groove, which is formed at or about a top dead center around an outer peripheral surface of the piston. The groove has a flat bottom surface. A piston ring is fitted into the groove. The ring has a truncated cone-shape and may be made of resin or the like. An external diameter of the piston ring is greater than that of the piston. The piston ring is disposed in the groove, such that the wider edge of the ring (i.e., the ring edge with the greater diameter) opens toward a bottom dead center of the piston and the narrower edge of the piston ring (i.e., the ring edge with the smaller diameter) abuts a bottom surface of the groove.

In another embodiment of a piston assembly for use in a compressor, such as a swash plate-type compressor or the like, having a plurarity of cylinder bores, each of which receives the piston assembly, the piston assembly reciprocates between a top dead center and a bottom dead center position in each of the cylinder bores. The piston assembly comprises a piston and a plurality of piston rings. Each piston has a plurarity of grooves, each of which is formed around an outer peripheral surface of the piston. Each groove has a flat bottom surface. A plurality of piston rings are fitted into each of the grooves. Each piston ring has a truncated cone-shape and may be made of resin or the like. An external diameter of each piston rings is greater than that of the piston. Each piston ring is disposed in one of the grooves, such that the wider edge of each ring opens toward a bottom dead center of the piston and the narrower edge of the piston ring abuts each of a bottom surface of the grooves.

Other objects, features, and advantages will be apparent to persons of ordinary skill in the art from the following description of the invention with reference to the accompanying drawings.

### BRIEF DESCRIPTION OF THE DRAWINGS

The present invention may be more readily understood with reference to the following drawings, in which:

FIG. 1 is a longitudinal, cross-sectional view of a piston-type compressor, according to the present invention;

FIG. 2 is an enlarged view of portion 60′ of the cylinder side wall depicted in FIG. 1, according to a first embodiment of the present invention;

FIG. 3 is an enlarged view of portion 60″ of the cylinder side wall depicted in FIG. 1, according to a second embodiment of the present invention; and

FIG. 4 is a cross-sectional view of a known piston ring.

### DETAILED DESCRIPTION OF PREFERRED EMBODIMENTS

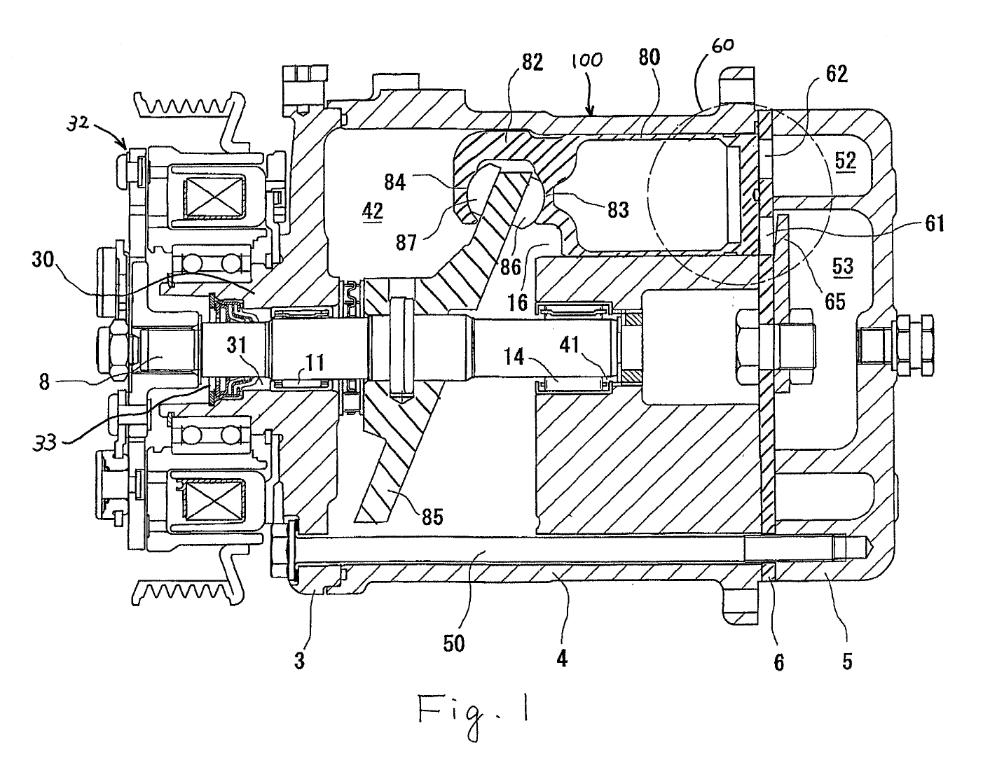

Referring to FIG. 1, a longitudinal, cross-sectional view of a piston-type compressor is shown. The piston-type compressor includes a casing having a space that draws refrigerant gas thereinto and discharges compressed refrigerant gas therefrom. The shell of compressor 100 comprises front housing 3, cylinder block 4, valve plate 6, and cylinder head 5. These parts are fixed together by a plurality of bolts 50. A plurality of cylinder bores 16 are radially formed in cylinder block 4 and are arranged with respect to the central axis of cylinder block 3. Central bore 41 is formed along the central axis of cylinder block 4. Crank chamber 42 is formed between front housing 3 and cylinder block 4. Suction chamber 52 and discharge chamber 53 are formed in cylinder head 5 and are adjacent to valve plate 6. Each of cylinder bores 16 communicates with suction chamber 52 and discharge chamber 53 through suction port 62 and discharge port 61. Suction port 62 is covered with a suction reed valve (not shown) and discharge port 61 is covered with a discharge reed valve (not shown). Valve retainer 65 is formed against the discharge reed valve to limit the opening of the reed valve to a predetermined amount or degree.

Drive shaft 8 extends along a central axis of compressor 100 and through crank chamber 42. One end of drive shaft 8 is rotatably supported by inside wall opening 31 through radial bearing 11 and shaft seal device 33. Inside wall opening 31 is formed in cylindrical-shaped shaft supporting portion 30 of front housing 3. Another end of drive shaft 8 also is rotatably supported by cylinder block 4 through radial needle bearing 14, which is disposed in central bore 41.

Swash plate 85 is fixedly mounted on drive shaft 8 in crank chamber 42 and rotates with drive shaft 8. Pistons 80 are accommodated in cylinder bores 16 and are independently and reciprocally movable therein. Hemispherical shoes 86 and 87 are disposed between each sliding surface of swash plate 85 and inner surfaces 83 and 84 of piston skirt portions 82 of pistons 80, so that pistons 80 may slide along the side surface of swash plate 85. Thus, each piston 80 is coupled to swash plate 85 through shoes 86 and 87. This coupling mechanism converts a rotating motion of the drive shaft 8 into a reciprocating movement of pistons 80. Piston skirt portions 82 are located outside of cylinder bores 16 and within cylinder block 4.

In operation, when a driving force is transferred from an external driving source (e.g., an engine of a vehicle) via a known belt and pulley arrangement and electromagnetic clutch 32, drive shaft 8 is rotated. Electromagnetic clutch 32 transmits a rotating force to drive shaft 8, or disconnects a rotating force from drive shaft 8. The rotation of drive shaft 8 is transferred to swash plate 85, so that, with respect to the rotation of drive shaft 8, the inclined surface of swash plate 85 moves axially to the right and the left. Consequently, pistons 80, which are operatively connected to swash plate 85 by means of shoes 86 and 87, reciprocate within cylinder bores 16. As pistons 80 reciprocate, refrigerant gas, which is introduced into suction chamber 52 from a fluid inlet port (not shown), is drawn into each cylinder bore 16 and is compressed. Referring to enlarged portion 60, pressure from the compressed refrigerant gas opens the discharge reed valve (not shown), and the refrigerant gas is discharged into discharge chamber 53 from each cylinder bores 16 and therefrom into a fluid circuit, for example, a cooling circuit, through a fluid outlet port (not shown).

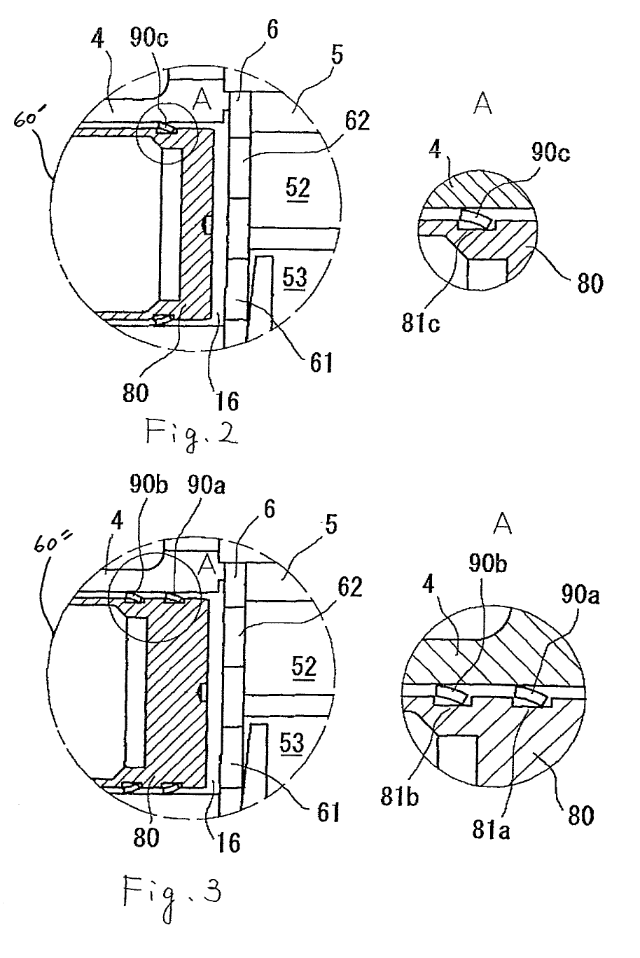

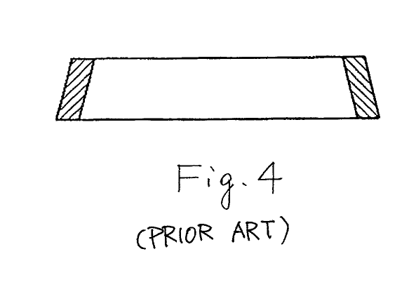

Referring to FIGS. 1 and 2, the piston-type compressor according to a first embodiment of the invention is shown. In enlarged portion A of enlarged portion 60′ of FIG. 2, groove 81c is formed around nearly a top dead center of an outer peripheral surface of piston 80. Groove 81c has a flat bottom surface thereof. Piston ring 90c, which has a truncated cone-shape and is made of resin, as shown in FIG. 4, is fitted into groove 81c. An external diameter of piston ring 90c is greater than that of piston 80. Piston ring 90c is disposed in groove 81c, such that the wider edge of the ring opens toward a bottom dead center of piston 80, and only the narrower edge of piston ring 90c abuts a bottom surface of groove 81c. Futher, an internal diameter of piston ring 90c is formed to be slightly smaller than an external diameter of the bottom surface of groove 81c before piston ring 90c is fitted into groove 81c. Piston ring 90c is forced to expand its diameter when piston ring 90c is fitted into groove 81c. Thus, the narrower edge of the internal diameter of piston ring 90c adheres to the bottom surface of groove 81c. Chamferring a top and bottom edge portion of groove 81c is within the contemplation of the present invention.

Significant reductions in the performance of the compressor are not experienced in the compressor having the structure of the first embodiment compared to, for example, the structure of one piston and two piston rings which is described in Japanese Second (Examined) Utility Model Publication No. 4-52473.

Referring to FIGS. 1 and 3, the piston-type compressor according to a second embodiment of the invention is shown. In enlarged portion A of enlarged portion 60″ of FIG. 3, first groove 81a is formed at or about nearly a top dead center around an outer peripheral surface of piston 80. Second groove 81b is formed around an outer peripheral surface of piston 80 that is offset toward a bottom center of piston 80, as compared to first groove 81a. Each of the bottom surfaces of first groove 81a and second groove 81b is a flat surface. Piston ring 90a and piston ring 90b, each of which has a truncated cone-shape and is made of resin, as shown in FIG. 4, are fitted into first groove 81a and second groove 81b, respectively. Each of the external diameters of piston ring 90a and piston ring 90b is greater than that of piston 80. Piston ring 90a and piston ring 90b are disposed in first groove 81a and second groove 81b, respectively, such that the wider edge of each ring opens toward a bottom dead center of piston, and only the narrower edges of piston ring 90a and piston ring 90b abut each of the bottom surfaces of first groove 81a and second groove 81b, respectively. Futher, each of the internal diameters of piston ring 90a and piston ring 90b is formed to be slightly smaller than each of external diameters of the bottom surfaces of first groove 81a and second groove 81b before each of piston ring 90a and piston ring 90b is fitted into first groove 81a and second groove 81b, respectively. Piston ring 90a and piston ring 90b are forced to expand their diameters when each of piston ring 90a and piston ring 90b is fitted into first groove 81a and second groove 81b. Thus, each of edges of the internal diameters of piston ring 90a and piston ring 90b adheres to the bottom surfaces of first groove 81a and second groove 81b, respectively. Chamferring each top and bottom edge portions of first groove 81a and second groove 81b is within the contemplation of the present invention.

In the piston-type compressor according to the present invention, blow-by gas, which leaks into crank chamber 42 from cylinder bores 16 during compressor operation, may increase compared to that of known piston-type compressors. Therefore, lubricating oil included in blow-by gas of the present invention may be increased compared to that of known piston-type compressors. In other words, on the one hand, restriction of a flow of blow-by gas into crank chamber 42 is relaxed, while, on the other hand, the flow of refrigerant gas from crank chamber 42 into cylinder bores 16 is substantially the same as that of known piston-type compressors. Consequently, the retention of refrigerant gas in crank chamber 42 in a swash plate-type compressor and the retention of refrigerant gas between swash plate 85 and shoes 86 and 87 may increase. As a result, lubricating oil in refrigerant gas lubricates sliding surfaces between swash plate 85 and shoes 86 and 87, and the durability of the swash plate and shoes may be increased.

Further, the compressive efficiency of the present invention may be slightly lower than that of the known compressor desclosed in Japanese Second (Examined) Utility Model Publication No. 4-52473 as measured using a calorie meter. However, the oil circulation ratio is improved, i e., the retention of lubricating oil in crank chamber 42 increases, and the discharge of lubricating oil into a refrigerant circuit decreases. As a result, in an air-conditioning system, a cooling performance may increase.

As described above, in the embodiments of the present invention of a piston-type compressor, groove 81c is formed at or about nearly a top dead center of an outer peripheral surface of piston 80. Groove 81c has a flat bottom surface thereof. Piston ring 90c, which has a truncated cone-shape and is made of resin. An external diameter of piston ring 90c is greater than that of piston 80. Piston ring 90c is disposed in groove 81c, such that the wider edge of the ring opens toward a bottom dead center of piston 80, and only the narrower edge of piston ring 90c abuts a bottom surface of groove 81c. An edge of the internal diameter of piston ring 90c adheres to the bottom surface of groove 81c. Therefore, sealing efficiency and efficiency of compressor operation may increase, and inclination of pistons 80 and the retention of lubricationg oil in cylinder bores 16 may decrease. Further, in a swash plate-type compressor, a wear between a swash plate and shoes may decrease.

Although the present invention has been described in connection with preferred embodiments, the invention is not limited thereto. It will be understood by those skilled in the art that variations and modifications may be made within the scope and spirit of this invention, as defined by the following claims.

What is claimed is:

1. A piston assembly for use in a compressor having a plurarity of cylinder bores, each of which receives the piston assembly, the piston assembly reciprocates between a top dead center and a bottom dead center position in each cylinder bores, the piston assembly comprising:
a piston having a groove, said groove formed at about a top dead center of an outer peripheral surface of the piston, and having a flat bottom surface thereof; and
a piston ring fitted into said groove, and having a truncated cone-shape;
wherein an external diameter of said piston ring is greater than that of said piston, and wherein said piston ring is disposed in said groove, such that a wider edge of the ring opens toward a bottom dead center of said piston and a narrower edge of said piston ring abuts a bottom surface of said groove.

2. The piston assembly of claim 1, wherein chamferred portions are formed each of a top and bottom edge portions of said groove.

3. The piston assembly of claim 1, wherein said piston ring is made of resin.

4. The piston assembly of claim 1, wherein said compressor is a swash plate-type compressor.

5. A piston assembly for use in a compressor having a plurarity of cylinder bores, each of which receives the piston assembly, the piston assembly reciprocates between a top dead center and a bottom dead center position in each cylinder bores, the piston assembly comprising:
a piston having a plurarity of grooves, said each grooves formed around an outer peripheral surface of the piston, and each having a flat bottom surface thereof; and
a plurality of piston rings fitted into each of said grooves, and each having a truncated cone-shape;
wherein an external diameter of each said piston ring is greater than that of said piston, and wherein each said piston rings is disposed in each said grooves, such that a wider edge of each ring opens toward a bottom dead center of said piston, and a narrower edge of said piston rings abuts each of a bottom surface of said grooves.

6. The piston assembly of claim 5, wherein chamferred portions are formed each of a top and bottom edge portions of each said grooves.

7. The piston assembly of claim 5, wherein each of said piston rings is made of resin.

8. The piston assembly of claim 5, wherein said compressor is a swash plate-type compressor.
